(19) United States
(12) Patent Application Publication
(10) Pub. No.: US 2012/0044073 A1
(43) Pub. Date: Feb. 23, 2012

(54) ELECTRONIC EQUIPMENT HAVING ANTITHEFT FUNCTION, AND EXTERNAL SERVER

(75) Inventor: Hideaki Watanabe, Osakasayama City (JP)

(73) Assignee: SANYO ELECTRIC CO., LTD., Moriguchi City (JP)

(21) Appl. No.: 13/194,175

(22) Filed: Jul. 29, 2011

(30) Foreign Application Priority Data
Aug. 18, 2010 (JP) 2010-183246

(51) Int. Cl. G08B 13/14; H04Q 5/22

(52) U.S. Cl. 340/568.1; 340/10.1

(57) ABSTRACT

An electronic equipment with Internet connection function includes a storage portion that stores product identification information assigned uniquely to each product, and a control portion that reads out the product identification information from the storage portion, generates a stolen item identification request signal containing the product identification information, and sends the stolen item identification request signal to an external server via the Internet. The control portion checks whether or not the electronic equipment is a stolen item, using a return signal from the external server that responds to the stolen item identification request signal.

### CROSS-REFERENCE TO RELATED APPLICATIONS

This nonprovisional application claims priority under 35 U.S.C. §119(a) on Patent Application No. 2010-183246 filed in Japan on Aug. 18, 2010, the entire contents of which are hereby incorporated by reference.

### BACKGROUND OF THE INVENTION

1. Field of the Invention

The present invention relates to electronic equipment having an antitheft function and to an external server that can provide the electronic equipment with information necessary for the electronic equipment to achieve an antitheft effect.

2. Description of Related Art

Commonly, there is a typical method of preventing electronic equipment from being stolen, for example, in which a sensor called a sensor tag is embedded in a product or a sensor tag is attached to a package box of the product, while a detecting sensor is installed near a door of a store, and a buzzer is activated if a product is taken out from the store without invaliding the sensor tag function by a register apparatus. However, this method has a disadvantage that work of attaching the sensor tag requires additional time and labor. In addition, if the sensor tag is removed from the product, the effect of the sensor tag is lost so that the buzzer is not activated even if the product is stolen. Therefore, the effect of this method is doubtful.

In addition, there is a conventional theft information management system, which enables efficient sharing of information about ownership of products and information about theft of products, so that trading of stolen items can be inhibited. The theft information management system includes a product management server having a product management database for recording product identification information assigned uniquely to each product and information about the owner of the product in an associated manner, and inquiry terminals that can mutually communicate with the product management server via a network.

In the theft information management system, the information about the owner of the product recorded in the product management database is personal information collected specially by a sales site, a support site, or a service site of a dealer of the product (a manufacturer or a distributor). Therefore, there is a problem that collection of the personal information requires additional time and labor. In addition, in the theft information management system, it is necessary to perform a special input operation (a designation of product identification information) using the inquiry terminal for inquiring about the owner. This operation also requires additional time and labor.

### SUMMARY OF THE INVENTION

According to an aspect of the present invention, an electronic equipment with Internet connection function includes a storage portion that stores product identification information assigned uniquely to each product, and a control portion that reads out the product identification information from the storage portion, generates a stolen item identification request signal containing the product identification information, and sends the stolen item identification request signal to an external server via the Internet. The control portion checks whether or not the electronic equipment is a stolen item using a return signal from the external server that responds to the stolen item identification request signal.

In addition, according to another aspect of the present invention, an external server includes a product identification information extracting portion that receives a stolen item identification request signal sent from an electronic equipment having the above-mentioned structure and extracts product identification information contained in the stolen item identification request signal, and a sales data obtaining portion that obtains sales data of the product corresponding to the product identification information extracted by the product identification information extracting portion, and a return signal generating portion that generates a return signal responding to the stolen item identification request signal based on the sales data obtained by the sales data obtaining portion. The sales data is data registered by a point of sale (POS) system.

Meanings and effects of the present invention will be apparent from the following description of embodiment. However, the embodiment described below is merely an example of the present invention, and meanings of the present invention and terms of components are not limited to those described in the following description.

### BRIEF DESCRIPTION OF THE DRAWINGS

FIG. 1 is a block diagram of a television receiver according to an embodiment of the present invention.

FIG. 2 is an example of a flowchart indicating a stolen item identification process performed by a television receiver as an embodiment of the present invention illustrated in FIG. 1.

FIG. 3 is a diagram illustrating an example of a message screen notifying that checking is being performed.

FIG. 4 is a diagram illustrating an example of a message screen notifying that the checking is completed.

FIG. 5 is a diagram illustrating an example of a retry message screen.

FIG. 6 is a diagram illustrating an example of an error message screen.

FIG. 7 illustrates another example of the flowchart of the stolen item identification process performed by the television receiver as an embodiment of the present invention illustrated in FIG. 1.

FIG. 8 is a block diagram illustrating a structural diagram of an external server according to an embodiment of the present invention.

### DETAILED DESCRIPTION OF THE PREFERRED EMBODIMENTS

An embodiment of the present invention will be described below with reference to the attached drawings.

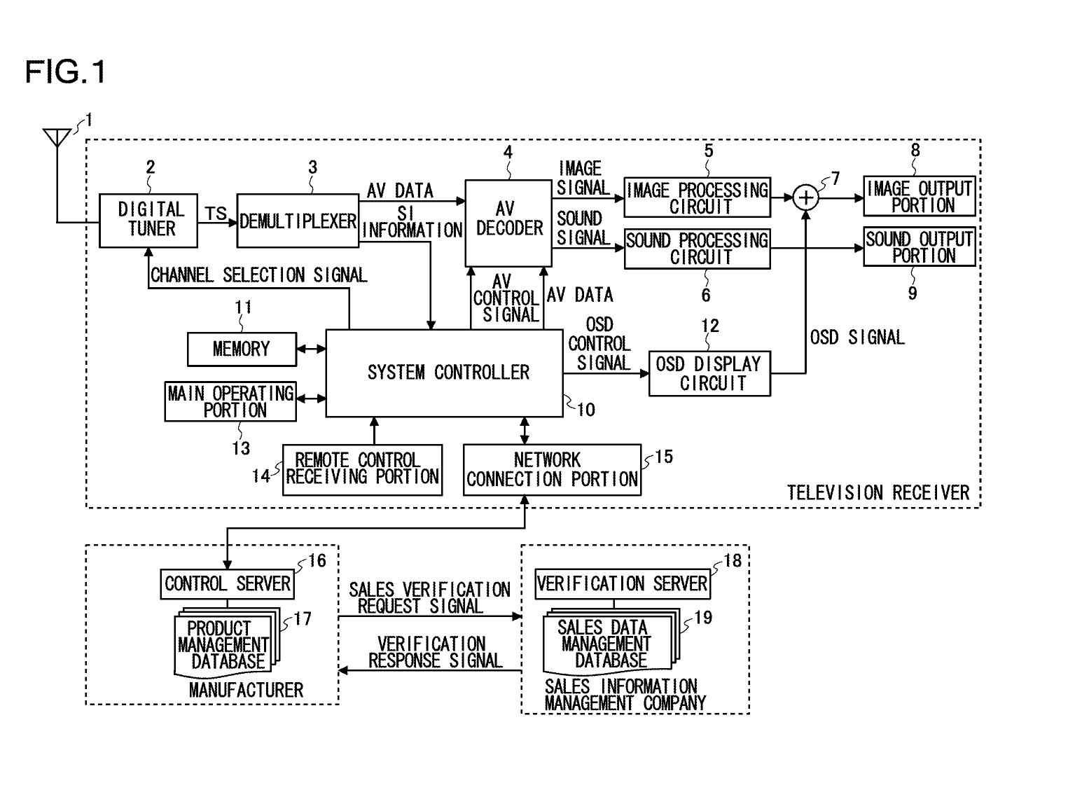

A block diagram of a television receiver according to the embodiment of the present invention is illustrated in FIG. 1. The television receiver according to the embodiment of the present invention illustrated in FIG. 1 is a television receiver with Internet connection function, and includes a digital tuner 2, a demultiplexer (DEMUX) 3, an AV decoder 4, an image processing circuit 5, a sound processing circuit 6, an adder 7, an image output portion 8, a sound output portion 9, a system controller 10, a memory 11, an on-screen display (OSD) display circuit 12, a main operating portion 13, a remote control receiving portion 14, and a network connection portion 15.

An antenna 1 receives digital broadcasting wave and supplies a reception signal to the digital tuner 2. The digital tuner 2 selects a physical channel by a channel selection signal from the system controller 10. The digital tuner 2 converts the reception signal that is a high frequency signal into a digitally modulated signal of the selected physical channel, which is a signal having a specific frequency, by the channel selection process. In addition, the digital tuner 2 includes a demodulation circuit or the like that demodulates the digitally modulated signal of the selected physical channel, and outputs a transport stream TS.

The demultiplexer (DEMUX) 3 demodulates an encrypted packet among packets of the transport stream TS received from the digital tuner 2. The packet is separated into AV data as contents of the broadcasting program and service information (SI). The AV data is output to the AV decoder 4 while the service information is output to the system controller 10.

The AV decoder 4 decodes the AV data received from the demultiplexer 3 or the system controller 10 into an image signal and a sound signal in accordance with an AV control signal output from the system controller 10. Then, the AV decoder 4 outputs the image signal to the image processing circuit 5 and outputs the sound signal to the sound processing circuit 6.

The image processing circuit 5 receives the image signal from the AV decoder 4 and performs a D/A conversion so as to generate an analog image signal. The sound processing circuit 6 receives sound data from an AV decoder 4 or a system controller 10 and performs a D/A conversion so as to generate an analog sound signal.

The system controller 10 performs various types of control of the television receiver in response to an operation command output from the main operating portion 13 that receives a key operation of a user, or to an operation command output from the remote control receiving portion 14 that receives a remote control infrared signal sent from a remote control transmitter (not shown) that receives a key operation of the user.

The memory 11 stores various programs and various data in a nonvolatile manner, which are necessary for the system controller 10 to perform various types of control of the television receiver.

The system controller 10 delivers an OSD control signal to the OSD display circuit 12 in accordance with the above-mentioned operation command or necessity of message display.

The OSD circuit 12 generates an OSD signal based on the OSD control signal sent from the system controller 10 and outputs the OSD signal to the adder 7.

The adder 7 superimposes the OSD signal output from the OSD circuit 12 on the analog image signal output from the image processing circuit 5, and the image signal obtained as a result thereof is supplied to the image output portion 8.

The image output portion 8 includes a display device (not shown), and the image corresponding to the image signal supplied from the adder 7 is displayed on a display screen of the display device.

The sound output portion 9 includes a speaker (not shown), and sound corresponding to an analog sound signal supplied from the sound processing circuit 6 is generated from the speaker.

The network connection portion 15 can easily connect to the Internet via a modem (not shown) connected to the network. When the network connection portion 15 receives contents on the Internet in accordance with control of the system controller 10, the system controller 10 outputs the AV data, which is the contents on the Internet received by the network connection portion 15, to the AV decoder 4.

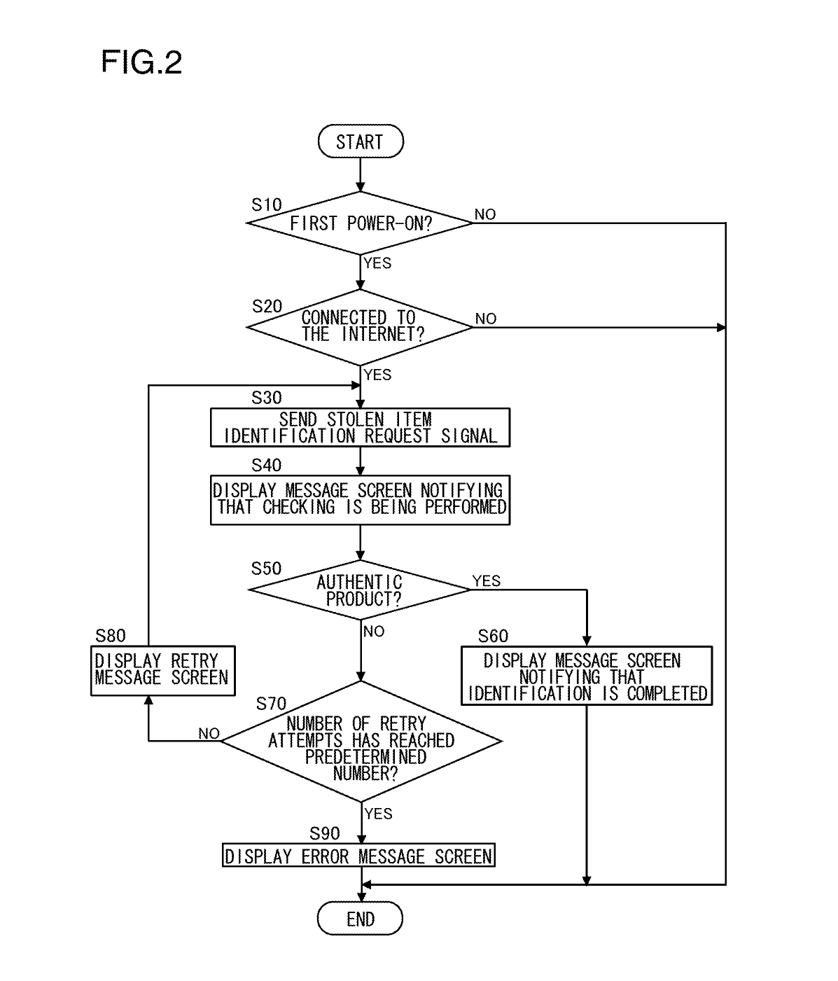

Next, FIG. 2 illustrates an example of a flowchart of a stolen item identification process performed by the television receiver according to the embodiment of the present invention illustrated in FIG. 1.

In the television receiver according to the embodiment of the present invention illustrated in FIG. 1, whenever power is turned on, the operation of the flowchart illustrated in FIG. 2 is started.

First, in Step S10, the system controller 10 checks whether the power-on operation is the first power-on or not. For instance, a first power-on flag for checking whether or not the first power-on has already been performed may be stored in the memory 11 in a nonvolatile manner, so that the system controller 10 can perform the checking of Step S10 by referring to the first power-on flag. In this case, it is preferable that a state of the first power-on flag can be rewritten from a state indicating that the first power-on has already been performed to a state indicating that the first power-on has not been performed yet, by selecting initialization (reset) of a whole setting in a set menu display screen, for example.

In the checking of Step S10, if it is decided that the power-on operation is not the first power-on (NO in Step S10), the operation of the flowchart illustrated in FIG. 2 is promptly finished without performing the checking process of Step S20 that will be described later and the stolen item identification process of Step S30 to Step S90 that will be described later.

On the contrary, in the checking of Step S10, if it is decided that the power-on operation is the first power-on (YES in Step S10), the system controller 10 checks whether or not the network connection portion 15 is connected to the Internet (Step S20).

In the checking of Step S20, if it is decided that the network connection portion 15 is not connected to the Internet (NO in Step S20), the operation of the flowchart illustrated in FIG. 2 is promptly finished without performing the stolen item identification process of Step S30 to Step S90 that will be described later. Therefore, the stolen item identification process of Step S30 to Step S90 that will be described later is performed only in the case where the power is turned on first time and the connection to the Internet is completed.

On the contrary, in the checking of Step S20, if it is decided that the network connection portion 15 is connected to the Internet (YES in Step S20), the system controller 10 reads out a product identification ID (product identification information assigned uniquely to each product) from the memory 11, generates a stolen item identification request signal containing the product identification ID, and sends the stolen item identification request signal to a control server 16 of the manufacturer via the network connection portion 15 (Step S30).

Note that the product identification ID is written in the memory 11 and is registered in a product management database 17 of the manufacturer in association with a product number (serial number) before factory shipment of the television receiver.

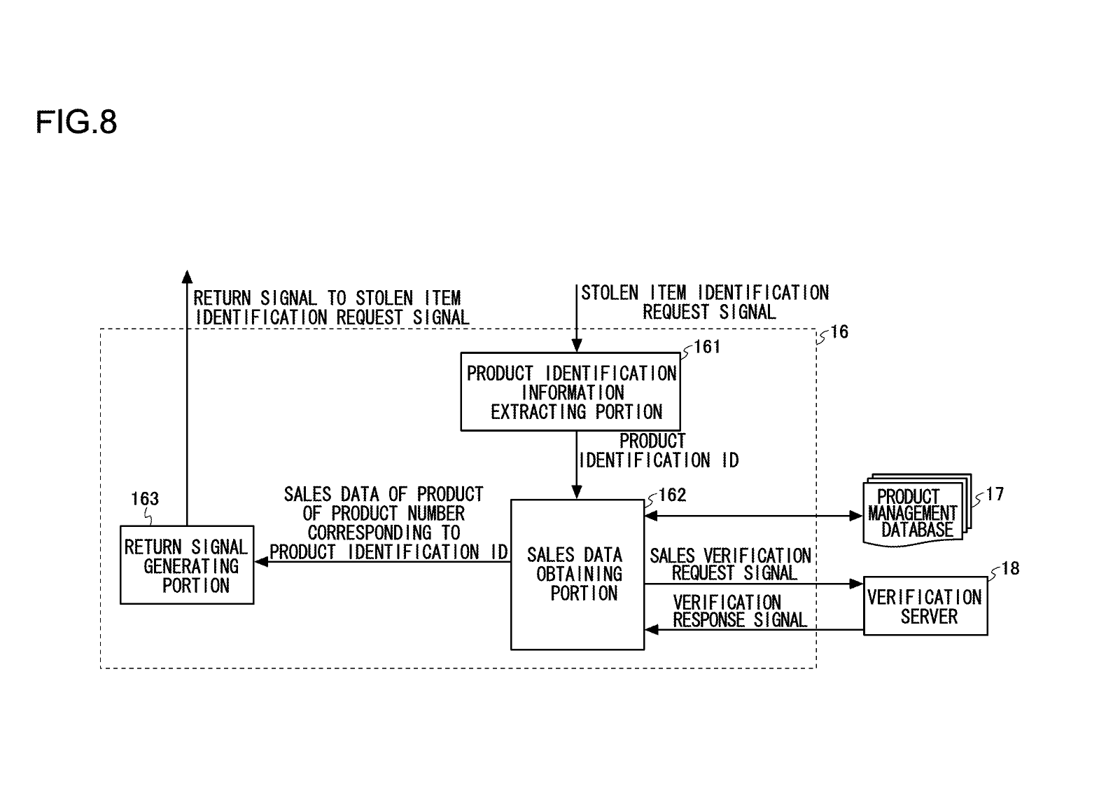

The control server 16 of the manufacturer includes a product identification information extracting portion 161, a sales data obtaining portion 162, and a return signal generating portion 163 as illustrated in FIG. 8, for example. When receiving the stolen item identification request signal, the product identification information extracting portion 161 extracts the product identification ID contained in the stolen item identification request signal. The sales data obtaining portion 162 makes access to the product management database 17 of the company, specifies the product number corresponding to the product identification ID extracted by the product identification information extracting portion 161, and sends a sales verification request signal containing the specified product number to a verification server 18 of a sales information management company that is an outside company (e.g., SIRAS (registered trademark) in North America). Note that the control server 16 and the verification server 18 may be mutually communicatable via the Internet or may be mutually communicatable via a dedicated line.

The verification server 18 of the sales information management company that has received the sales verification request signal makes access to its own sales data management database 19, extracts sales data about the product of the product number contained in the sales verification request signal, and sends back a verification response signal containing the extracted sales data to the sales data obtaining portion 162 of the manufacturer's control server 16. The sales data obtaining portion 162 obtains sales data about the product of the product number corresponding to the product identification ID extracted by the product identification information extracting portion 161 from the verification response signal. The sales data is registered in the sales data management database 19 of the sales information management company by the point of sale (POS) system just after a retailer sells the product. By utilizing the sales data, it is possible to trace when, where and of what product number the product was sold. Note that the sales information management company is not limited to a company that manages sales information of every market but may be a company that manages sales information of only a particular market.

The return signal generating portion 163 of the manufacturer's control server 16 receives the sales data obtained by the sales data obtaining portion 162 from the sales data obtaining portion 162, checks whether or not the product to be verified is an authentic product based on the sales data received from the sales data obtaining portion 162, generates a result of the checking as a return signal to the stolen item identification request signal, and sends the generated return signal to the television receiver according to the embodiment of the present invention illustrated in FIG. 1 via the Internet.

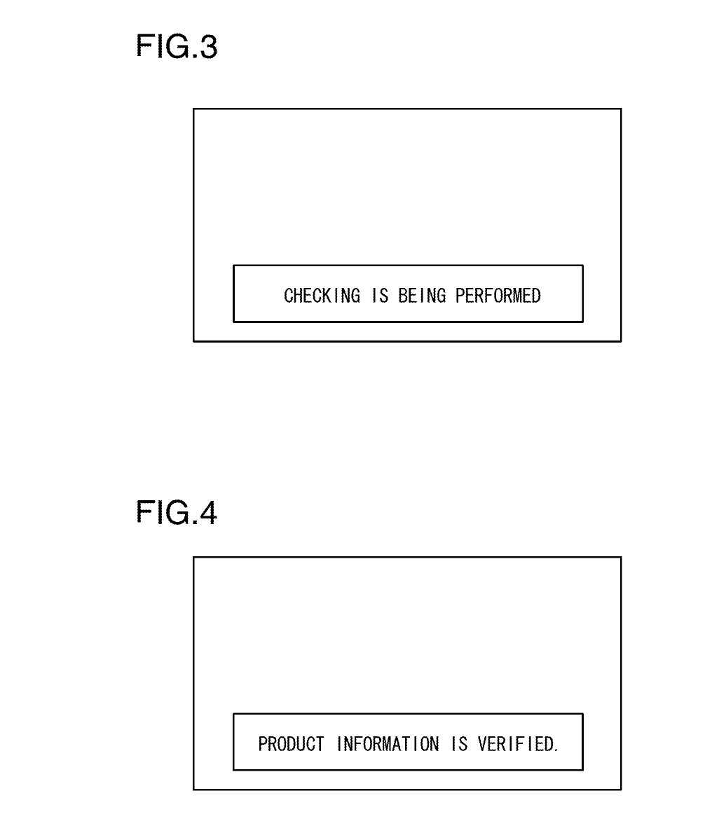

In the television receiver according to the embodiment of the present invention illustrated in FIG. 1, during a period of time after the stolen item identification request signal is sent in Step S30 until the notification from the control server 16 is received, the display device of the image output portion 8 displays a “message screen notifying that the checking is being performed” like a message screen illustrated in FIG. 3, for example (Step S40).

Then, the television receiver according to the embodiment of the present invention illustrated in FIG. 1 receives the notification from the control server 16, and the system controller 10 checks whether or not the television receiver according to the embodiment of the present invention illustrated in FIG. 1 is a legally sold product (authentic product) based on the notification (Step S50).

If it is decided to be an authentic product in the checking of Step S50 (YES in Step S50), the display device of the image output portion 8 displays a “message screen notifying that the identification is completed” like a message screen illustrated in FIG. 4, for example (Step S60). After that, the operation of the flowchart illustrated in FIG. 2 is finished. Note that the display of the “message screen notifying that the identification is completed” may be automatically turned off after a predetermined time lapses from start of the display or may be turned off by a user's operation.

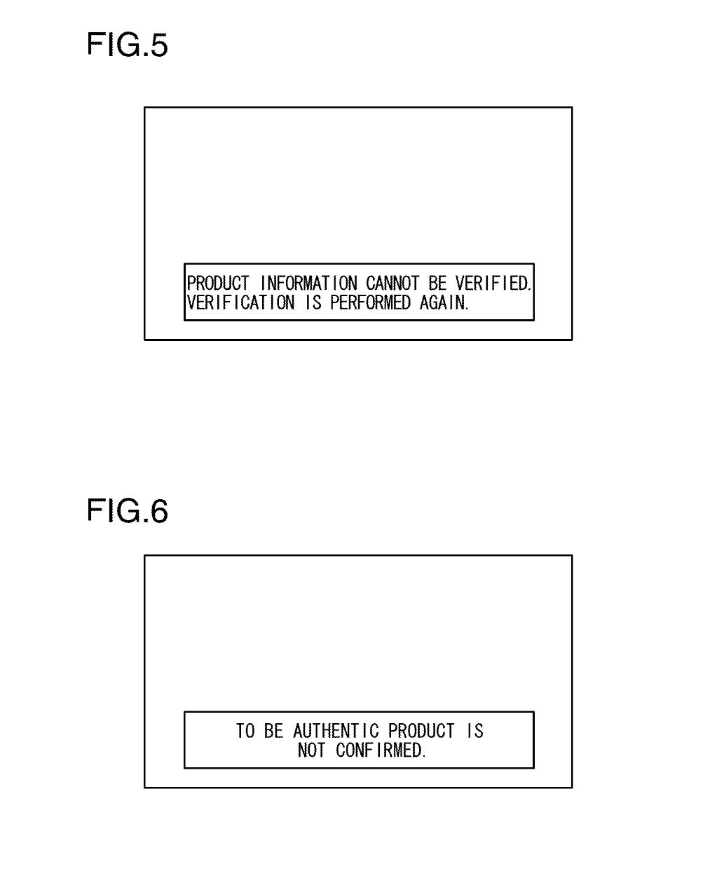

On the contrary, if it is decided to be not an authentic product in the checking of Step S50 (NO in Step S50), it is considered that a certain communication trouble or the like may have occurred, so retry of the checking is repeated a predetermined times. Specifically, the system controller 10 first checks whether or not the number of retry attempts has reached a predetermined number (Step S70). In the checking of Step S70, if it is decided that the number of retry attempts has not reached the predetermined number (NO in Step S70), the display device of the image output portion 8 displays a “retry message screen” like a message screen illustrated in FIG. 5, for example (Step S80). After that, the process flow goes back to Step S30. On the contrary, in the checking of Step S70, if it is decided that the number of retry attempts has reached the predetermined number (YES in Step S70), the display device of the image output portion 8 displays a “error message screen” like a message screen illustrated in FIG. 6, for example (Step S90). After that, the operation of the flowchart illustrated in FIG. 2 is finished.

According to the operation described above, if the television receiver according to the embodiment of the present invention illustrated in FIG. 1 is not an authentic product, the “error message screen” is displayed in the case where the power is turned on for the first time and the Internet connection is completed. Because use of a stolen item is inhibited by the display of the “error message screen”, the television receiver according to the embodiment of the present invention illustrated in FIG. 1 has an antitheft effect. In addition, in the television receiver according to the embodiment of the present invention illustrated in FIG. 1, a user or a dealer of the product is not required to perform a special input operation or the like for the stolen item identification process. It is sufficient only to use the product management database and the sales data management database that are usually generated. Therefore, the antitheft effect can be obtained without imposing additional time and labor on a user or a dealer of the product.

The embodiment of the present invention is described above, but the scope of the present invention is not limited to the embodiment, which can be modified variously without deviating from the scope of the spirit of the present invention.

For instance, in the flowchart illustrated in FIG. 2, instead of the process of Step S90, or together with the process of Step S90, it is possible to perform payment request display that urges to pay for the product as a stolen item by a predetermined method, return request display that urges to return the product as a stolen item to a predetermined address, a process of disconnecting network connection after that, a process of disabling power-on after that, a process of restricting to view TV broadcasting programs or contents on the Internet, or the like.

In addition, for example, in the flowchart illustrated in FIG. 2, it is possible to reset the number of retry attempts and to go back to Step S30 whenever the process of Step S90 is finished.

In addition, for example, instead of the procedure in which the manufacturer's control server 16 checks whether or not the product to be verified is an authentic product based on the sales data contained in the verification response signal, and sends a result of the checking to the television receiver according to the embodiment of the present invention illustrated in FIG. 1 via the Internet, it is possible to adopt the procedure in which the manufacturer's control server 16 transfers the sales data contained in the verification response signal to the television receiver according to the embodiment of the present invention illustrated in FIG. 1 via the Internet, and the television receiver according to the embodiment of the present invention illustrated in FIG. 1 checks whether or not the product to be verified is an authentic product.

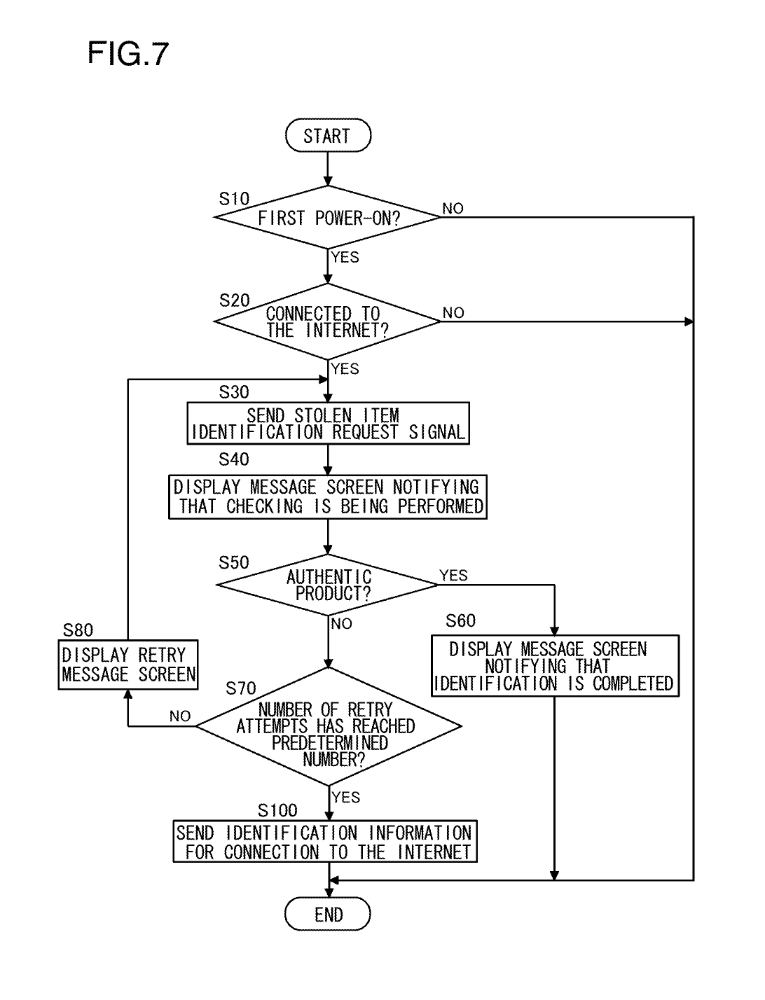

In addition, for example, it is possible that the television receiver according to the embodiment of the present invention illustrated in FIG. 1 performs the operation of the flowchart illustrated in FIG. 7 instead of the operation of the flowchart illustrated in FIG. 2. Note that the same steps in FIG. 7 as those in FIG. 2 are denoted by the same numerals so that overlapping detailed description is omitted.

In the flowchart illustrated in FIG. 7, if it is decided in the checking of Step S70 that the number of retry attempts reaches the predetermined number (YES in Step S70), the system controller 10 sends identification information for connection to the Internet (e.g., an IP address) assigned to the television receiver according to the embodiment of the present invention illustrated in FIG. 1 to the manufacturer's control server 16 via the network connection portion 15 (Step S100), and the operation of the flowchart illustrated in FIG. 7 is finished. Thus, if the television receiver according to the embodiment of the present invention illustrated in FIG. 1 is a stolen item, the manufacturer can easily locates the television receiver according to the embodiment of the present invention illustrated in FIG. 1. Note that it is possible to dispose Step S90 of FIG. 2 between Step S70 and Step S100 in the flowchart illustrated in FIG. 7.

In addition, even if the retry is attempted a plurality of times, a misdecision may occur in the checking of Step S50 due to a malfunction of the server or the like, and hence the error display may be performed in mistake. Therefore, it is desirable that a service person can cancel a result of the misdecision. For instance, it is desirable that a result of the misdecision can be canceled by a special key operation that is not described in the user manual.

In addition, the control server 16 and the product management database 17 may be integrated in the embodiment described above.

In addition, the present invention can be generally applied to any electronic equipment with Internet connection function without limiting to the television receiver.

What is claimed is:

1. An electronic equipment with Internet connection function, comprising:
a storage portion that stores product identification information assigned uniquely to each product; and
a control portion that reads out the product identification information from the storage portion, generates a stolen item identification request signal containing the product identification information, and sends the stolen item identification request signal to an external server via the Internet, wherein
the control portion checks whether or not the electronic equipment is a stolen item, using a return signal from the external server that responds to the stolen item identification request signal.

2. The electronic equipment according to claim 1, further comprising a display signal generating portion that generates a display signal for warning display when the control portion decides that the electronic equipment is a stolen item, and generates a display signal for check finish display when the control portion decides that the electronic equipment is not a stolen item.

3. The electronic equipment according to claim 2, wherein when the decision that the electronic equipment is a stolen item is repeated a predetermined number of times, content of the display signal for warning display is changed.

4. The electronic equipment according to claim 3, wherein when the decision that the electronic equipment is a stolen item is repeated a predetermined number of times, the content of the display signal for warning display is changed to that for any one of error message display, payment request display that urges to pay for the product as a stolen item by a predetermined method, and return request display that urges to return the product as a stolen item to a predetermined address.

5. The electronic equipment according to claim 1, wherein when the control portion decides that the electronic equipment is a stolen item, the control portion sends the identification information for connection to the Internet assigned to the electronic equipment to an external server via the Internet.

6. The electronic equipment according to claim 1, wherein when the control portion decides that the electronic equipment is a stolen item, the control portion restricts functions of the electronic equipment.

7. The electronic equipment according to claim 6, wherein when the control portion decides that the electronic equipment is a stolen item, the control portion performs at least one of a process of disconnecting network connection after that, a process of disabling power-on after that, and a process of restricting to view contents.

8. An external server comprising:
a product identification information extracting portion that receives a stolen item identification request signal sent from an electronic equipment and extracts product identification information contained in the stolen item identification request signal;
a sales data obtaining portion that obtains sales data of the product corresponding to the product identification information extracted by the product identification information extracting portion; and
a return signal generating portion that generates a return signal responding to the stolen item identification request signal based on the sales data obtained by the sales data obtaining portion, wherein
the electronic equipment has Internet connection function and includes a storage portion that stores product identification information assigned uniquely to each product, and a control portion that reads out the product identification information from the storage portion, generates a stolen item identification request signal containing the product identification information, and sends the stolen item identification request signal to an external server via the Internet, and wherein
the control portion checks whether or not the electronic equipment is a stolen item, using the return signal, and wherein
the sales data is data registered by a point of sale (POS) system.
